(19) United States
(12) Patent Application Publication
(10) Pub. No.: US 2015/0080110 A1
(43) Pub. Date: Mar. 19, 2015

(54) System and Method for Sports Wager Tournaments

(71) Applicant: Robert J. Griffith, Columbia, SC (US)

(72) Inventor: Robert J. Griffith, Columbia, SC (US)

(21) Appl. No.: 14/031,564

(22) Filed: Sep. 19, 2013

(51) Int. Cl. G07F 17/32

(52) U.S. Cl. CPC G07F 17/3288
USPC 463/25

(57) ABSTRACT

A system and method for conducting a sports wager tournament, wherein players pay an entry fee and attempt to predict the outcomes of multiple sporting events. Each player receives a sum of tournament play money, and a list of sporting events with pre-established odds for each contestant or team. The players make predictions for projected winners of the sporting events, and assign portions of the play money as wagers to each projected winner. The projected winners for each player are compared to the outcomes of the actual events and assigned credits for winning selections in relation to the pre-established odds that are applicable to each contest, as well as the amount of play money wagered for the specific projected winner. The player who generates the most credits wins either a large portion or all of the pot, which consists of the entry fees paid in by all players.

### BACKGROUND OF THE INVENTION

The present invention relates generally to systems and methods for wagering on sporting events. More specifically, the present invention includes a system and method for conducting a sports wager tournament, wherein players pay an entry fee and attempt to predict the outcomes of multiple sporting events. Each player receives a sum of tournament play money, and a list of sporting events with pre-established odds for each contestant or team. The players make predictions for projected winners of the sporting events, and assign portions of the play money as wagers to each projected winner. The projected winners for each player are compared to the outcomes of the actual events and assigned credits for winning selections in relation to the pre-established odds that are applicable to each contest, as well as the amount of play money wagered for the specific projected winner. The player who generates the most credits wins either a large portion or all of the pot, which consists of the entry fees paid in by all players.

Parlay betting has become popular throughout the U.S., particularly in relation to college football and NFL football. Typically, a player receives a card having a list of football games (or other sporting events) to be played on a given day or a given weekend, together with the odds or lines for each contest. The player first elects how many different games he wishes to predict on the parlay card. If a player wishes to predict the winners of a higher number of games, then the odds, and thus the payout, are increased. In other words, if a player selects three games to predict (and thus predicts three winners), then the payout will be less than if he chooses (and correctly predicts the outcome of) five games. Generally, in order to win by betting on a parlay card, the player must correctly predict the outcome of each game selected. If the player incorrectly predicts the outcome of a single game or contest, then he receives no payout. Also, the entry fee for a parlay card may be determined by how many games/winners the player wishes to predict, so that if a player wants to select three winners on a parlay card, he may have to pay $3 to play, but if he wishes to select five winners, he may have to pay $5, and the payout on a winning $5 card is much greater than the payout on a winning $3 card, because the difficulty of successfully predicting the outcome of five sporting events is much higher than the difficulty of successfully predicting the outcome of three sporting events.

Normally, a parlay card player is simply competing against the house, and is not competing against other players. For example, if a player successfully fills out a parlay card, he is paid by the house, regardless of the outcomes of any other parlay players who used the same parlay card. One reason that parlay cards have become popular in recent years is that it allows a player a chance to win based on a small entry fee, and gives the player a reason to watch multiple sporting events, with a stake in the outcome. Many parlay players may watch an NFL game that includes a team selected on their parlay card, only because of their stake in the outcome, when they might not normally watch that particular game if they didn't have a stake in the outcome.

The present system and method for conducting a sports wager tournament works somewhat differently than the standard parlay sports betting set forth above. The present system combines the parlay style betting with a tournament, where the players are competing against each other in order to win money, which is generated by the entry fees paid by the players, as described herein.

### BRIEF SUMMARY OF THE INVENTION

In accordance with one aspect of the invention, a system and method for conducting sports wager tournaments is provided. The tournament allows players to pay an entry fee, and in return, the player is provided with a list of sporting events, together with the odds associated with each event and contestant. The player is also provided with a credit for a specific amount of “play money.” The player may then attempt to predict the winner each sporting event listed, taking into account the odds associated with each contest, and may assign his play money to each prediction in any amount he wishes, so long as the cumulative wagers are equal to the amount of play money initially assigned to that player. After the sporting events have come to their conclusion and the winners are declared for each event, the player receives credits of play money, which are determined by 1) which of his predictions were successful, and of those, 2) the odds associated with that particular sporting event, and 3) how much play money was wagered on that particular contest. In other words, if a player successfully chooses an underdog, according to the pre-established odds, then he will receive more credits for that prediction than if he had successfully chosen a favorite (based on the pre-established odds). Further, if a player concentrated most of his play money on one contest, and successfully predicted that contest, then the payout will be greater than if he had wagered a lesser amount of play money on that contest. The winner of the tournament is declared after all of the sporting events have concluded, and the winner of the tournament is the player who has accumulated the most credits at the conclusion of the events.

The winnings may be distributed in any desirable manner. In one embodiment, the winner simply receives all of the money generated as entry fees for the tournament. In another embodiment, the winnings may be distributed in some incremental fashion between the top two or three (or more) players, with the top finisher receiving more money than the second and third place players. It is contemplated that this system may be implemented as web-based software, to allow players to enter, pay and play, and even to receive winnings through a website, a software app on a mobile device, or the like.

### BRIEF DESCRIPTION OF THE DRAWINGS

These and other features, aspects, and advantages of the present invention will become better understood with regard to the following description, appended claims, and accompanying drawings where:

FIG. 1 is a graphic depiction of a tournament parlay card, in accordance with one aspect of the present invention; and

FIG. 2 is a graphic depiction of a spreadsheet, showing a list of players as well as their selected wagers and their projected winners in a series of sporting events, in accordance with one aspect of the present invention.

### DETAILED DESCRIPTION OF THE INVENTION

The present invention includes a system and method for conducting a sports wager tournament, wherein players compete among themselves to accurately predict a series of sporting events. The players each pay an entry fee, and are provided with a list of sporting events that are the subject of the waivers. For example, the players may participate in a series of wagers based on several mixed martial arts fights, including the undercard fights and the main event. Each player is awarded a certain amount of play money (ie. $500), and the player selects his projected winner for each bout. Then, the player assigns an amount of the play money to each of the projected winners, in any amount he sees fit, so that the total amount of money bet on all events equals the $500 amount of play money initially assigned to the player. If the player is most confident in a particular fight, then he can apply a large majority of (or all of) his play money to that fighter. Alternatively, the player can spread his play money evenly through the fights, or may wager heavily on some fighters and less on others. The player's selections must be made and wagers on each bout set before any of the fights begin.

At the conclusion of each fight, the players are awarded credits, based on 1) whether their chosen boxer won the match, 2) the pre-established odds associated with that boxer, and 3) how much play money was assigned to that boxer. In this way, the player's selections are weighted, so that if he assigns more play money to a successful boxer, the player receives more credits. Further, the selections are weighted by the odds associated with the boxer, so that more credits are awarded to a player who selects an underdog, instead of a favorite based on the pre-established odds for that fight. In one embodiment, the odds on each boxer are the standard Las Vegas odds, although other odds may be used, as desired. If the player chooses a boxer who ultimately loses the fight, then no credits are awarded to the player for that particular selection.

After all of the fights have concluded, and the winners of the fights have been declared, then the weighted credits are awarded to each player accordingly. The winner of the tournament is the player who has accumulated the most credits for the tournament. The prize money is generated by the entry fees paid by the players to enter the tournament. Winnings can be distributed in any desired manner, either by winner-take-all, or by dividing the winnings up among several of the top scoring players in an incremental manner, with the highest ranking player receiving the most money, and each successive place receiving less money. In one embodiment, the players finishing in the top 30% of all players in the tournament, based on accumulated credits, may receive a payout.

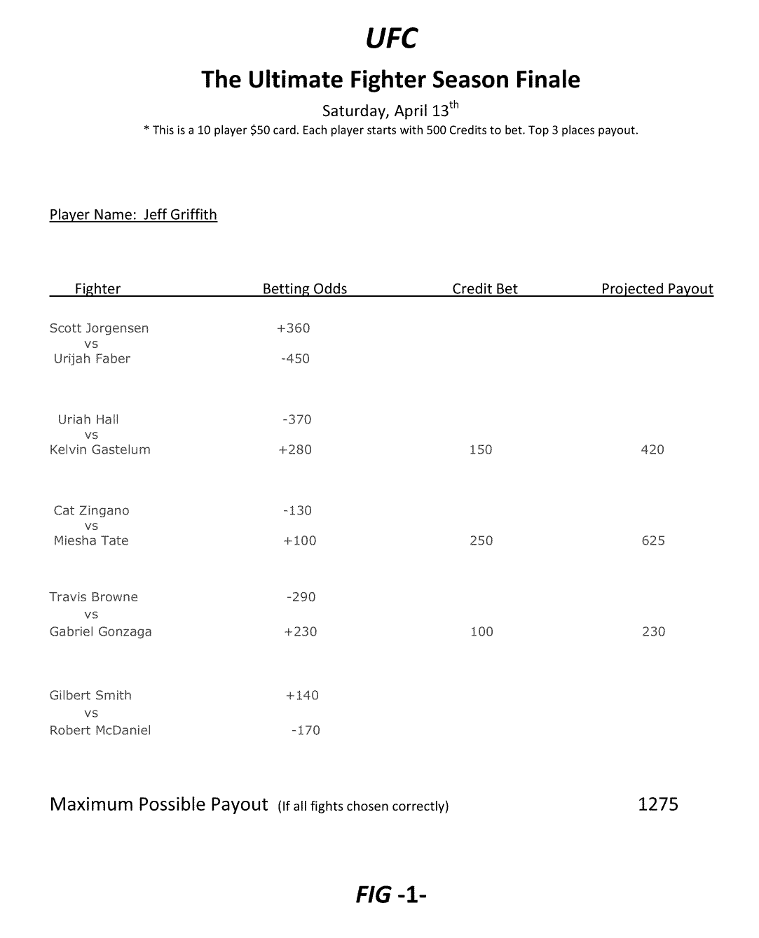

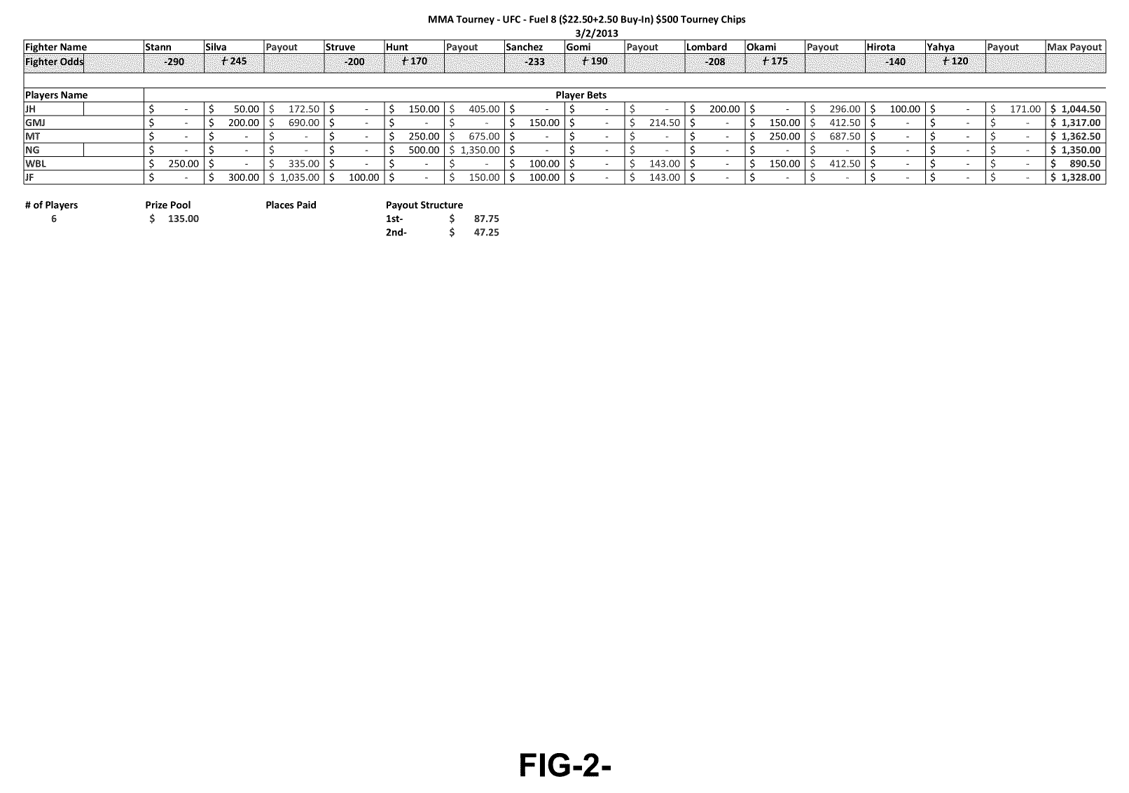

FIG. 1 shows an example of a fight card that tournament participants may use to participate in the tournament. Tournament participants, for these purposes, shall be referred to as “bettors,” as opposed to the actual fighters or combatants in the sporting events themselves. FIG. 2 shows a spreadsheet style interactive chart for a mixed martial arts tournament. In this example, the top two lines of the sheet list the fighters and the odds of each fighter winning their respective fight. The bettors are listed vertically on the left hand side of the sheet. Each bettor uses his $500 play money to bet on any or all of the fights. Each bettor may only place a bet on one of the two fighters, but not both. Additionally, each bettor must use all of his $500 to bet on the fights, but may bet all of it on one fight, or spread it out among several or all fights, so long as his total bets equal the $500 play money assigned for the tournament.

The system may be set up to use standard Las Vegas odds, or any other odds, as desired. In this example, the tournament is based on a series of Mixed Martial Arts (MMA) fights. The players may wish to bet on one of the fighters in the first match listed on the sheet, which includes Stann (first fighter having odds listed at −290) and Silva (second fighter having odds listed at +245), as set forth in FIG. 1. The negative number designates the favorite to win the fight, and indicates the amount of money required to win $100. So, in order to win $100 betting on Stann, a bettor must bet $290. If a bettor bets $290 on Stann, and Stann wins his fight, then the bettor is awarded their initial $290 plus the $100 extra for the win. The positive number designates the underdog, and means that if a person bets $100, then they would receive his original bet, plus an extra $245 in the case of Silva in this example.

So, for someone who bets, for instance, $250 on Stann, and Stann wins the bout, then the calculation for the final payout is as follows:

((100÷odds)×bet)+bet=final payout

((100÷290)×$250)+$250=$335

Typically, the odds calculation is rounded to the nearest two decimal places, so that in this case, the odds calculation (100÷290)=0.344827, which would be rounded to 0.34. Then the rest of the calculation uses the 0.34 number as the odds calculation.

Conversely, if someone bets $300 on the underdog, in this case Silva, then the calculation is as follows:

((odds÷100)×bet)+bet=final payout

((245÷100)×300)+$300=$1035

The bettor who garners the most play money or credits after all of the fights have taken place, wins first prize. As stated before, first prize may include the entire pool of the entry fees, or may include a majority portion of the entry fees, so that some entry fee money could be used as a payout for second place, and possibly third place, etc.

It is contemplated that the present system for conducting a sports wager tournament may be incorporated into a web-based software program, where the players may participate by using computers, mobile devices, tablets and the like. In such a web-based system, the entry fees may be paid via credit card transaction, via PayPal, or any other electronic money transferring system. The wagers may be placed on each sporting event and team (or contestant) selections made online by each player. The web-based system may also keep a real-time scoreboard or spreadsheet, showing each player's wagers, the amount of credits accumulated, and the projected credits if each player's selections ultimately become winners of their respective matches or events. Additionally, winnings may be transferred to players or player accounts online at the end of the tournament, so that the entire tournament may be conducted online electronically. It is also contemplated that the web-based system may incorporate a messaging system or chat-room feature, so that the players may communicate with each other during the tournaments.

In one embodiment, the web-based system may also include a spreadsheet that allows a player to enter different dollar amounts in association with a particular boxer (or team), and automatically calculates the credit payouts if that boxer wins his match. FIG. 1 is an example of this type of spreadsheet, which also may be updated online in real time. This feature helps a player to adjust his betting before the fights begin, because he can see what the payout will be for different amounts of money applied to individual fighters (or teams) before submitting the final amounts and selections. The player may enter in a set of bet amounts for different boxers, and if he or she does is not satisfied with the projected credit payout, the player may then adjust the amounts, or select opposing fighters (underdogs, for instance), in order to increase the projected payout.

In terms of strategy, a player may select mostly favorites, which are more likely to win than underdogs, but the credit payout will be less than if he selected underdogs. On the other hand, if the player selects mostly underdogs, the payout will be greater, but only if the underdogs win, which makes such a strategy more risky. Some players may wish to select a mix of favored boxers (or teams) and underdogs, in order to properly manage or balance their risk.

This system allows a person to participate in betting on a series of sporting events, and even if the bettor doesn't correctly select winners in each fight, he or she may still be in contention to win the tournament. Additionally, the betting requires skill and strategy, because the bettor must not only choose how many and which fights (or other sporting events) that are listed on the card or sheet to bet on, but must also determine how much to bet on each fight, in order to maximize the potential credit payout. This system also provides a motivation for bettors to watch various fights and sporting events that they may not normally have an interest in, which could increase, for instance, pay-per-view sales for such events.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for conducting a sports wager tournament, said method comprising the steps of:
establishing a group of players;
collecting entry fees from each player;
providing a list of sporting events to each player, said listing of sporting events including pre-established odds for each contestant or team competing in said sporting events;
assigning each player an initial amount of play money;
allowing each player to select a projected winner for each listed sporting event;
allowing each player to assign a desired amount of play money to each projected winner;
awarding credits to each player based on 1) whether the projected winner actually won the sporting event, 2) how much play money was assigned by the player to the projected winner, and 3) the pre-established odds of that projected winner winning the sporting event;
awarding at least a portion of the entry fees collected from all players to the player who has accumulated the most credits after all of said listed sporting events have concluded.

2. The method set forth in claim 1, wherein said tournament is conducted electronically via the Internet.

3. The method set forth in claim 2, further including the step of providing a means for allowing said players to electronically communicate with one another while said tournament is in progress.

4. The method set forth in claim 2, further including the step of providing each player with a listing of all players wagers, projected winners, and potential credit payouts while said tournament is in progress.
